(19) United States
(12) Patent Application Publication
(10) Pub. No.: US 2007/0169104 A1
(43) Pub. Date: Jul. 19, 2007

(54) Data processing apparatus

(75) Inventor: Akemi Morita, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA BUSINESS TECHNOLOGIES, INC., Tokyo (JP)

(21) Appl. No.: 11/447,314

(22) Filed: Jun. 5, 2006

(30) Foreign Application Priority Data
Dec. 8, 2005 (JP) JP2005-354334

(51) Int. Cl. G06F 9/44

(52) U.S. Cl. 717/170

(57) ABSTRACT

A data processing apparatus connected with an external device via network, including: an obtaining section to obtain first version information of first program stored in the external device; a comparison section to compare the first version information with second version information of second program stored in the data processing apparatus; a reference information generating section to generate reference information, which is used in the external device for determining whether the second program substitutes the first program or not, when the second program is later than the first program in accordance with a result of a comparison by the comparison section; and a reference information transmission section to transmit the reference information to the external device.

### RELATED APPLICATION

The present application is based on Japanese Patent Application No. 2005-354334 filed with Japan Patent Office on Dec. 8, 2005, the entire content of which is hereby incorporated by reference.

### BACKGROUND

1. Field of the Invention

The present invention relates to a data processing apparatus capable of updating a program. More particularly, the present invention relates to a data processing apparatus for updating a program by transmitting and receiving the program among apparatuses connected via network.

2. Descriptions of the Related Art

In the data processing apparatus operated by programs, the programs are updated to newer version programs in order to add new functions and to fix bugs in the programs. In order to decrease the man-hour related to the program update work described above, a system for automatically updating programs between apparatuses connected with network has been proposed. For example, a system disclosed in JPA-H11-282656 (Japanese Patent Application Publication Open to Public Inspection No. H11-282656) is arranged to have capability of setting whether the program update is automatically conducted or not. When setting automatic update, apparatuses connected with network compare the version of the programs each other. Then an apparatus having a newer version program is arranged to automatically update an older version program of an apparatus by the newer version program.

When automatically updating the program to a newer version program as described above, there is a case that problems caused by the update to the newer version program happen to occur.

For example, when the changes by the version-up relates to additions of functions which an end-user does not need and/or the changes are countermeasures of a bug occurring when installing a special optional apparatus, which the end-user does not install, the version-up is not necessary for the end-user, and becomes inconvenient for the end-user because of the down-time for the updates.

When current data and application programs come to the situation where the current data and the application programs cannot be used or installation of a certain optional apparatus becomes necessary due to the version-up, the automatic update to a newer version program gives bad effect for the users.

### SUMMRAY

An object of the present invention is to provide a data processing apparatus in which a user can determine whether update is necessary or not when updating a program between devices connected via network by transmitting and receiving a program between devices connected via network to resolve the problems described above.

In view of foregoing, an object of this invention is to solve at least one of the problems, and to provide new data processing apparatus. The apparatus comprises,

an obtaining section to obtain first version information of first program stored in the external device;

a comparison section to compare the first version information with second version information of second program stored in the data processing apparatus;

a reference information generating section to generate reference information, which is used in the external device for determining whether the second program substitutes the first program or not, when the second program is later than the first program in accordance with a result of a comparison by the comparison section; and

a reference information transmission section to transmit the reference information to the external device.

According to another aspect of the present invention, The apparatus comprises, a transmission section to transmit version information of second program stored in the data processing apparatus;

a reception section to receive reference information, which is used for determining whether the first program substitutes the second program or not, when the first program is later than the second program;

a display section to display the reference information for a user;

a selection section to accept an instruction of the user whether the first program substitutes the second program or not; and

an update section to update the second program by the first program, when the instruction is accepted at the selection section.

According to another aspect of the present invention, The apparatus comprises, an obtaining section to obtain first version information of first program stored in the external device;

a transmission section to transmit second version information of second program stored in the data processing apparatus;

a comparison section to compare the first version information with the second version information of second program stored in the data processing apparatus;

a reference information generating section to generate first reference information, which is used in the external device for determining whether the second program substitutes the first program or not, when the second program is later than the first program in accordance with a result of a comparison by the comparison section;

a reference information transmission section to transmit the first reference information to the external device;

a reception section to receive second reference information, which is used for determining whether the first program substitutes the second program or not, when the first program is later than the second program in accordance with the result of the comparison;

a display section to display the second reference information for a user;

a selection section to accept an instruction of the user whether the first program substitutes the second program or not; and

an update section to update the second program by the first program, when the instruction is accepted at the selection section.

The invention itself, together with further objects and attendant advantages, will best be understood by reference to the following detailed description taken in conjunction with the accompanying drawings.

### BRIEF DESCRIPTION OF THE DRAWINGS

These and other objects, advantages and features of the invention will become apparent from the following description thereof taken in conjunction with the accompanying drawings in which:

FIG. 1 illustrates an example of a system configuration in which a plurality of multi-functional apparatuses of the first embodiment of the present invention is connected with network;

FIG. 2 illustrates an electrical block diagram of the multi-functional apparatus of the first embodiment of the present invention;

FIG. 3 illustrates a functional block diagram of the multi-functional apparatus related to program update;

FIG. 4 illustrates a program configuration, which is provide to the other apparatus;

FIG. 5 illustrates a flowchart for describing the operation of the multi-functional apparatus newly connected with network;

FIG. 6 illustrates a flowchart for describing reference information generating process;

FIG. 7 illustrates an operation sequence when the second multi-functional apparatus including the second program, which is later version than the first version of the first program is connected with network to which the first multi-functional apparatus having the first version program has been connected;

FIG. 8 illustrates an operation sequence in which the second multi-functional apparatus having the second program, which has older version than the first version of the first program is connected with network to which the first multi-functional apparatus having the first version program has been connected;

FIG. 9 illustrates an example of a storage section, which stores programs and reference information;

FIG. 10 illustrates an example including an operation screen used when updating software and a confirmation screen for confirming the reference information; and

FIG. 11 illustrates a block diagram of a configuration of a program server and a multi-functional apparatus of the second embodiment of the present invention.

In the following description, like parts are designated by like reference numbers throughout the several drawings.

### DETAILED DESCRIPTION OF THE PREFEERED EMBODIMENTS

Various embodiments of the present invention will be described by referring to drawings below.

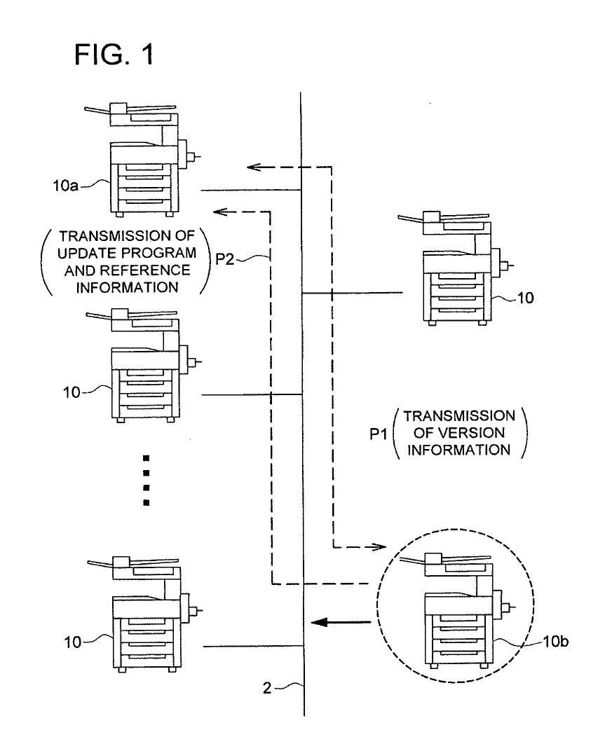

FIG. 1 illustrates a system configuration in which a plurality of multi-functional apparatuses 10 as data processing apparatuses of the first embodiments of the present invention is connected with network 2 such as LAN (Local Area Network). The multi-functional apparatus 10 has a printing function for extending print data into image data and printing the image data onto a recording paper sheet and a facsimile function for sending and receiving the image data in addition to a copy function for reading original documents, forming and outputting the copied imaged onto the recording paper sheet.

FIG. 1 illustrates a situation where a multi-functional apparatus 10b is newly introduced and about to be connected with the network 2 with which the plurality of multi-functional apparatuses 10 has already connected. In this system, the multi-functional apparatus 10b, which is newly connected with the network 2 searches the same type of multi-functional apparatus 10 (for example, a multi-functional apparatus 10a in FIG. 1) on its own initiative, which has already been connected with the network 2. Then, the multi-functional apparatus 10b and the same type of multi-functional apparatus 10a exchange the version information of the firmware each other (P1 in FIG. 1). Then, the version information of the firmware has been compared in each apparatus. The apparatus having later version firmware transmits the later version firmware which the own apparatus holds and reference information for determining whether the later version firmware substitutes the older version firmware or not to the apparatus having older version firmware (P2). The version to be compared is the latest version among plural versions in the case that an apparatus holds a plurality of versions of firmware or programs.

An apparatus receiving the firmware and the reference information and having older version firmware stores the correlation between the received later version firmware and the reference information, displays the reference information which has been stored onto a operation panel when a user conducts a predetermined operation, and provides the user with the reference information to determine whether the later version firmware substitutes the older version firmware. When receiving user's direction for updating the firmware, the apparatus receiving the firmware and the reference information is arranged to updates the older version firmware to the firmware, which has been specified in the user's instruction.

The reference information is information for becoming a judging material when determining whether the update is necessary or not and whether the update is suitable or not, when substituting an old version program to a later version program. For example, the multi-functional apparatus 10 includes various optional apparatuses such as a finisher for applying post-processing, such as punching, folding and staple processes to recording paper sheets after printing, and a large capacity paper sheet feeder. The configuration of each apparatus is different each other based on the installation state of optional apparatuses. The property of an internal program is also different each other depending on the existence of an application program and its version differences.

There is possibility that data compatibility is lost and new problems occur if a later program is installed without consideration under these conditions. In order to avoid these inconveniences, not only changes between versions but also advice information such as possible impacts or possible inferences occurring to later version programs when programs such as firmware is updated are provided to a user as reference information.

Concretely describing, there are differences between the programs before updated and newer programs (modification points and fixed points related to fixed bugs and newly added functions), information related to optional apparatuses and different programs required when programs are updated, various advice information related to the program update and warnings related to possible inconveniences anticipated when the program is updated. With regard to the advice information, listed can be a message for recommending addition of optional apparatuses and application programs, a message for guiding how to obtain the optional apparatus and application programs, and information indicating required time for updating programs.

In this embodiment, a case that the target program to be updated is firmware of an apparatus has been described. However, the target program may be other type of programs such as a driver-program and application programs. Also, the data processing apparatus is not limited to the multi-functional apparatus 10. It may be other apparatuses such as a printer and a server.

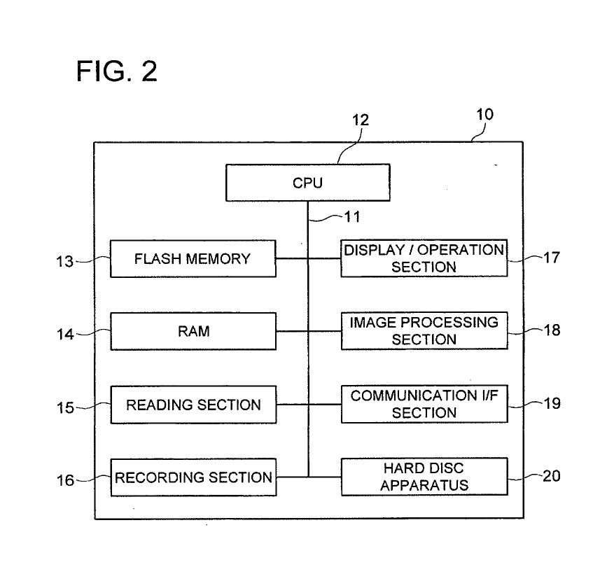

FIG. 2 illustrates an electrical block diagram of the multi-functional apparatus 10. The multi-functional apparatus 10 comprises a CPU (Central Processing Unit) 12, a flash memory 13, RAM (Random Access Memory) 14, a reading section 15, a recording section 16, a display/operation section 17, an image processing section 18, a communication I/F section 19 and a hard disc apparatus 20, all of which are connected with bus a bus 11.

The CPU 12 has a function for totally controlling the operation of the multi-functional apparatus 10. The flash memory 13 is non-volatile memory capable of being electrically rewritable, into which firmware, drive-programs and application programs are stored. The RAM 14 is used for temporarily storing data as work memory when the CPU 12 executes various programs and also used for temporarily storing image data as image memory.

The reading section 15 irradiates light beams onto original documents, optically reading out the reflected light beams by using a photo detector such as a CCD (Charge Coupled Device) and outputs image data corresponding to the reflected light beams.

The recording section 16 is configured as a printer engine having a laser system therein, which forms an image onto a recoding paper sheet by an electro-photographic process. The image processing section 18 has a function for correcting image data, a function for magnifying/reducing an image and a function for rotating an image.

The display/operation section 17 has a function for displaying various operation screens and guide screens for a user and a function for accepting various instructions from a user. The display/operation section 17 comprises, for example, a liquid crystal display having a touch panel on the surface of the liquid crystal display and operation switches.

The communication I/F section 19 has a function for communicating with an external device and other multi-functional apparatus 10 via network 2. The hard disk apparatus 20 is a non-volatile memory apparatus having large capacity. In this embodiment, a magnetic disk apparatus is used. The hard disk apparatus 20 stores image data, later version firmware received from other multi-functional apparatus 10 and reference information. If the later version firmware received from other multi-functional apparatus 10 and the reference information can be non-volatility stored, a storage apparatus, such as the flash memory 13 may be used instead of the hard disk apparatus 20.

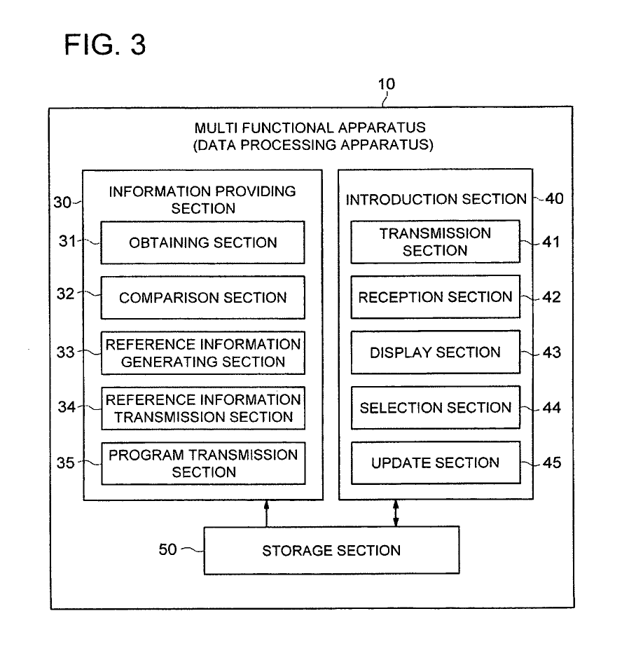

FIG. 3 illustrates a functional block diagram of the multi-functional apparatus 10 related to program update. The multi-functional apparatus 10 comprises an information providing section 30 for providing a program of own apparatus to the other apparatus, an introduction section 40 for receiving a program provided by the other apparatus and introducing the program provided by the other apparatus to own apparatus and a storage section 50 for storing the program provided for other apparatus and the program from the other apparatus, which are functional sections related to the firmware update.

The information providing section 30 comprises an obtaining section 31 for obtaining the version information of firmware (the first program) which was held by the first multi-functional apparatus from the other multi-functional apparatus 10 (the first multi-functional apparatus) connected via network 2, a comparison section 32 for comparing the version information of the first program obtained by the obtaining section 31 with the version information of the firmware (the second program) held by own apparatus (the second multi-functional apparatus), a reference information generating section 33 for generating reference information for a user to determine whether the second program substitutes the first program or not in the first multi-functional apparatus when the second program version is later than the first program version held by the first multi-functional apparatus based on the comparison by the comparison section 32, a reference information transmission section 34 for transmitting the reference information generated by the reference information generating section 33 and a program transmission section 35 for transmitting the second program to the first multi-functional apparatus.

The introduction section 40 comprises a transmission section 41 for transmitting the version information of the second program held by own apparatus (the second multi-functional apparatus) to the other multi-functional apparatus 10 (the first multi-functional apparatus) connected via network and a reception section 42 for receiving reference information sent from the first multi-functional apparatus when the first multi-functional apparatus has a later version program than the second program. A storage section 50 stores the reference information received by the reception section 42.

The introduction section 40 further comprises a display section 43 for displaying each reference information stored in the storage section 50 to the user, a selection section 44 for receiving the user's selection whether the program provided from the other multi-functional apparatus substitutes the second program held by own apparatus or not and a update section 45 for updating the second program held by own apparatus to the program corresponding to an update instruction when receiving the update instruction by the selection section 44.

The CUP 12, the communication I/F section 19 and the display/operation section 17 shown in FIG. 2 can realize each function of the information providing section 30 and the introduction section 40. The flash memory 13 and the hard disk apparatus 20 can realize the function of the storage section 50.

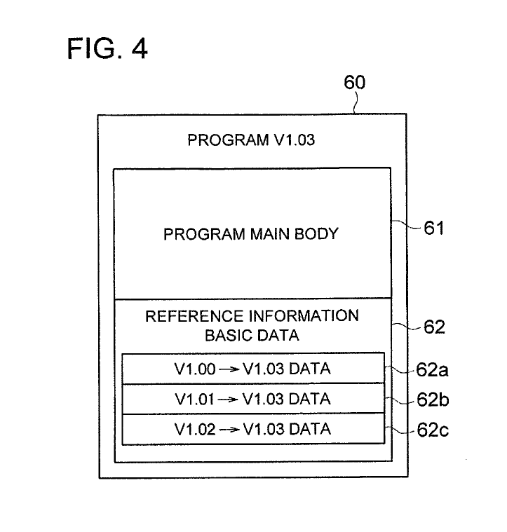

FIG. 4 illustrates a configuration example of a program 60, which is provided for the other apparatus. The program 60 includes a main body of the program 61 and reference information basic data 62 being basic data for producing reference information to be provided when updating the older version program than the version of the program 60 to the program 60. In this example, the version of the program 60 is V1.03. Since there are older versions such as V1.00, V1.01 and V1.02, which are older than V1.03, the program 60 includes basic data 62a for updating the program from V1.00 to V1.03, basic data 62b for updating the program from V1.01 to V1.03, and basic data 62c for updating the program from V1.02 to V1.03 as reference information basic data 62.

Each basic data 62a-62c includes judging information used for selecting necessary reference information for the other apparatus corresponding to the apparatus configuration, the existence or non-existence of other program (the third program) and the version of the program in addition to the information, which will be provided for the other apparatuses, such as changes (differences) between versions and advice information.

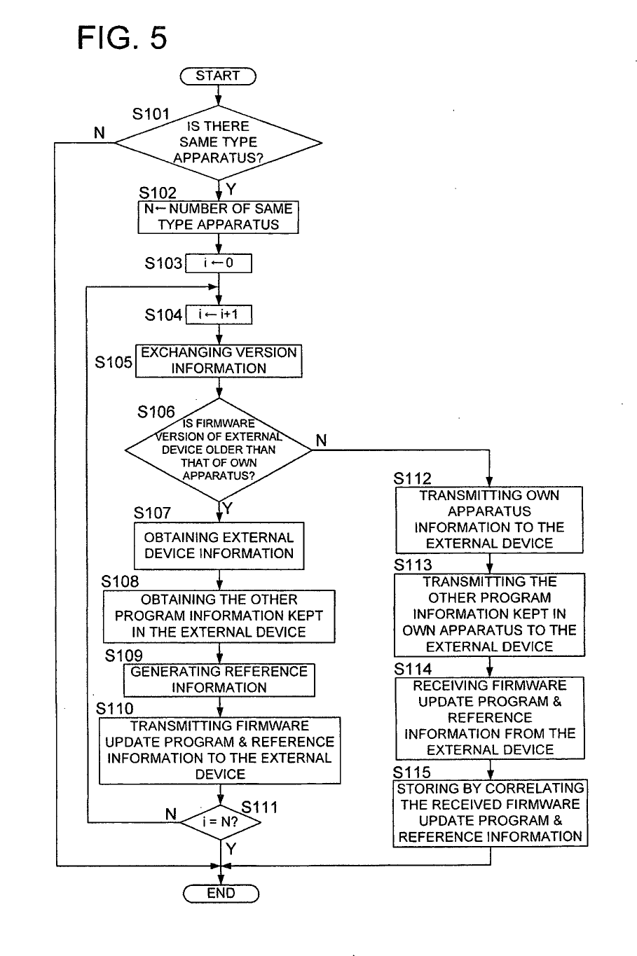

FIG. 5 illustrates a flowchart showing the operation of the multi-functional apparatus 10 newly connected with the network 2. The CPU 12 of the multi-functional apparatus 10 searches all the multi-functional apparatuses 10, which are the same type of model as own apparatus in the network 2 (Step S101) when having detected that own apparatus has been connected with the network 2 via the communication I/F section 19. If the same type apparatus as the multi-functional apparatus 10 has not been detected (Step S101; N), then the process ends (End).

When there is the same type of apparatus as the multi-functional apparatus 10 (Step S101; Y), the CPU 12 temporarily stores the network address of the detected multi-functional apparatus 10 and executes following processes to each multi-functional apparatus 10. Concretely describing, the CPU 12 sets the number of the same type of apparatus as the multi-functional apparatus 10, which has been detected, to a variable N (Step S102), and initializes a variable “i” to 0 (zero) (Step S103). Then the CPU 12 adds “1” to the variable “i” (Step S104) and repeats a series of processes against the “i”-th multi-functional apparatus 10 until the variable “i” reaches to the variable “N” (Step S111; Y).

In the series of processes described above, the information of the latest firmware version in each apparatus is exchanged between own apparatus and an external device (Step S105). Then the CPU 12 compares the latest firmware version of own apparatus and the latest firmware version of the external device (Step S106). If the external firmware version is older than the own firmware version (Step S106; Y), then the CPU 12 obtains the external device information (information related to a hard disk apparatus and a finisher) (Step 107), and further obtains application program (the third program) information (program information) (Step S108), which is different from the firmware held by the external device. The information includes at least property information of the other program (the third program), which will be affected by the firmware update.

Then, the CPU 12 generates reference information corresponding to the characteristic of the external device (Step S109) based on the firmware version differences between own apparatus and the external device, the apparatus information obtained from the external device and other program information, and transmits the reference information and the firmware of own apparatus to the external device (Step S110). For example, the CPU 12 includes a list of advice including the information whether the introduction of the later firmware version affects the optional apparatus and current programs which has been already installed, and information introducing application programs recommended to install, together with the changes between versions of the firmware into the reference information, and transmits them.

After that, the CPU 12 checks whether the external device is the last apparatus to be processed (Step S111). If it is not the last apparatus (Step S111; N), then the CPU 12 returns to step 104 and executes the same process against the next external device. If it is the last apparatus (step S111; Y) then the CPU 12 ends the process.

When the firmware version of the external device is later or newer than the firmware version of own apparatus based on the comparison of firmware versions (Step S106; N), the CPU 12 transmits the apparatus information of own apparatus to the external device (Step S112), and further transmits the information of the application program (the third program) which is different from the firmware held by own apparatus to the external device (Step S113). The external device which receives the information, executes the same processes as steps S107-S110, generates reference information and transmits the reference information and the firmware of the external device to own apparatus.

In own apparatus, the CPU 12 receives the reference information and the firmware sent from the external device (Step S114), correlates and stores the reference information and the firmware (Step S115). Then the CPU 12 ends the process (End). The reference information, which has been stored is read out when a user later conducts a predetermined operation, and displayed on the display/operation section 17. The stored reference information is used as judging material when the user determines whether the firmware should be updated or not. When receiving the instruction from the user to update the firmware, the CPU 12 reads out the firmware corresponding to the version from stored data and executes update-process for updating the current firmware in the flash memory 13.

In FIG. 5, the process ends after step S115. However, the process against the rest of the external devices may be continued. Further, in step S106 in FIG. 5, when the versions of both firmware are the same, the process may be shifted to step S111 with no-operation to continue the process.

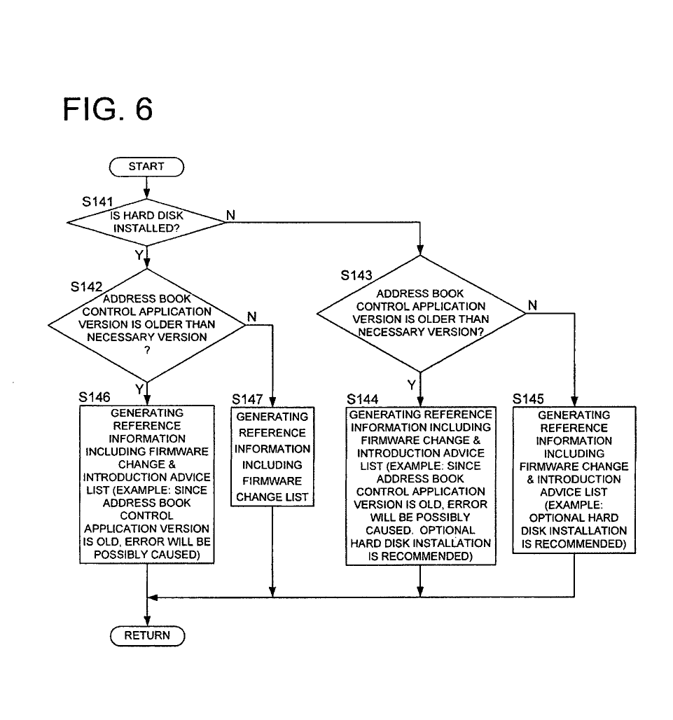

FIG. 6 illustrates an example of reference information generating process in step S109 of FIG. 5. Here, the CPU 12 obtains the information indicating the existence or non-existence of the hard disk apparatus as the apparatus information and information related to an address book control program as the other program (third program) other than the firmware, and generates reference information based on the information described above. In this example, the firmware having the latest version of own apparatus has a high performance address book control function and the function can be realized with an apparatus having a hard disk apparatus. Accordingly, it may give bad effects on the address book control function when applying the latest firmware version on the apparatus having no hard disk apparatus or the apparatus having an address book control program of an old version.

In the reference information generation process, the CPU 12 is arranged to determine whether the external device has installed a hard disk apparatus or not (Step S141) and whether the version of the address book control program of the external device is older than necessary version or not (Step S142 and S143). When the external device has not installed the hard disk apparatus and the version of the address book control program is older than the necessary version (Step S141; N, Step S143; Y), the CPU 12 generates reference information (step 144) including the changes of firmware and a list of introduction advice (for example, a message “Since the version of address book control application program is old, some inconvenience may occur. It is strongly recommended to install an optional hard disk drive.”).

When the external device has not installed the optional hard disk apparatus but includes an address book control program having a version newer than the necessary version (Step S141; N, Step S143; N), the CPU 12 generates reference information including the firmware changes and introduction advice list (for example, a message “An optional hard disk installation is recommended.”) (Step S145).

When the external device has installed the optional hard disk apparatus but includes an address book control program of older version than the necessary version (Step S141; Y, Step S142; Y), the CPU 12 generates reference information (Step S146) including the firmware changes and introduction advice list (for example, a message “Since address book control application version is old, error will be possibly caused.”).

If the external device has installed an optional hard disc apparatus and an address book control program having a later version than necessary version (Step S141; Y, Step S142; N), the CPU 12 generates only a firmware change list (Step S147).

As described above, since reference information such as apparatus configuration of the external device and the type and version of application program (the third program) corresponding to the characteristics of the external device are generated, unnecessary advice information for the external device cannot to be included in the reference information. As a result, it becomes possible for the user of the external device to efficiently judge whether the user updates the firmware or not based on the reference information.

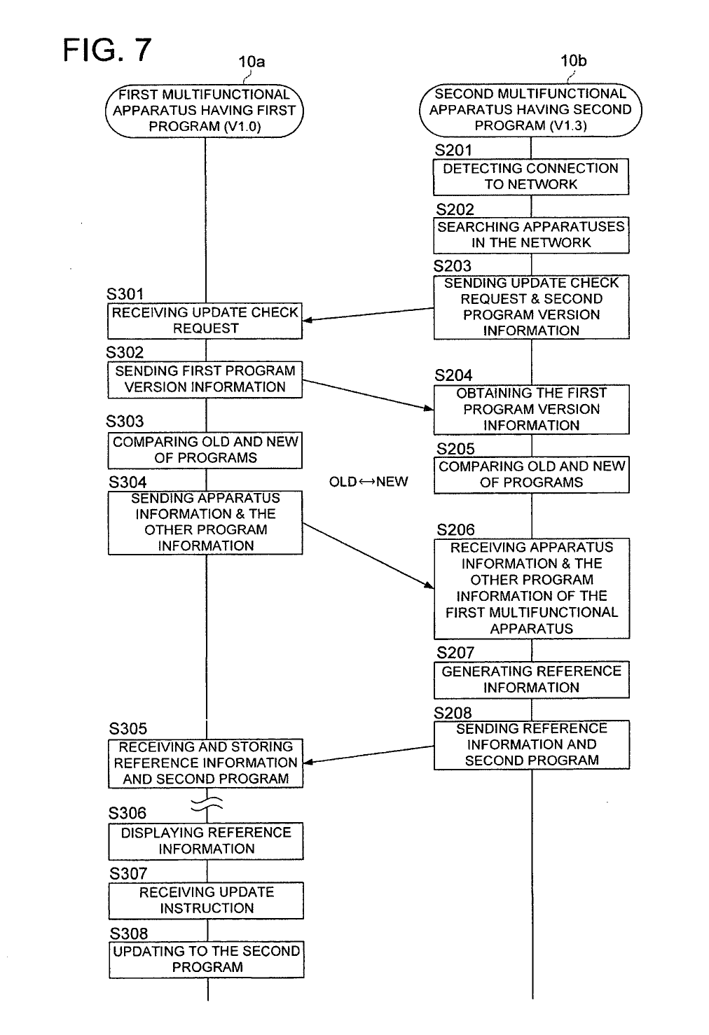

FIG. 7 illustrates the operation of the first and the second multi-functional apparatuses 10a and 10b when the second multi-functional apparatus 10b is newly connected with network 2 with which the first multi-functional apparatus has been connected. In FIG. 7, the first multi-functional apparatus 10a has a first program (version V1.0) and the second multi-functional apparatus 10b has a second program (version V1.3), which is newer (later) than the version of the first program.

When the second multi-functional apparatus 10b detects the connection to the network 2 (S201), then searches and detects the first multi-functional apparatus 10a in the network 2 (Step S202). Then the second multi-functional apparatus 10b transmits the update check request and the second program version information to the first multi-functional apparatus 10a (Step S203). The first multi-functional apparatus 10a, which received the update check request (step S301) transmits the first program version information back to the second multi-functional apparatus 10b (Step S302). The second multi-functional apparatus 10b receives the program version (Step S204). Based on a series of operation described above, each program version information is exchanged.

After that, each of the first multi-functional apparatus 10a and the second multi-functional apparatus 10b compares the version of the first program and the version of the second program (S205, S303). Since the first program (V1.0) held by the own apparatus is older than the second program (V1.3), the first multi-functional apparatus 10a transmits the apparatus information of own apparatus and the information related to other program (the third program) to the second multi-functional apparatus 10b (Step S304). The second multi-functional apparatus 10b receives them (Step S206), and generates the reference information (Step S207) based on the received information and version differences between the first and the second programs. The second multi-functional apparatus 10b transmits the generated reference information and the second program to the first multi-functional apparatus 10a (Step S208). The first multi-functional apparatus 10a receives and stores the information (Step S305).

The stored reference information is read out when a user conducts a predetermined operation on the first multi-functional apparatus and is displayed on the display/operation section 17 of the first multi-functional apparatus (Step S306). The user determines whether the user updates the first program to the second program or not by referring to the display. The first multi-functional apparatus updates the first program to the second program (Step S308) when receiving update instruction from the user.

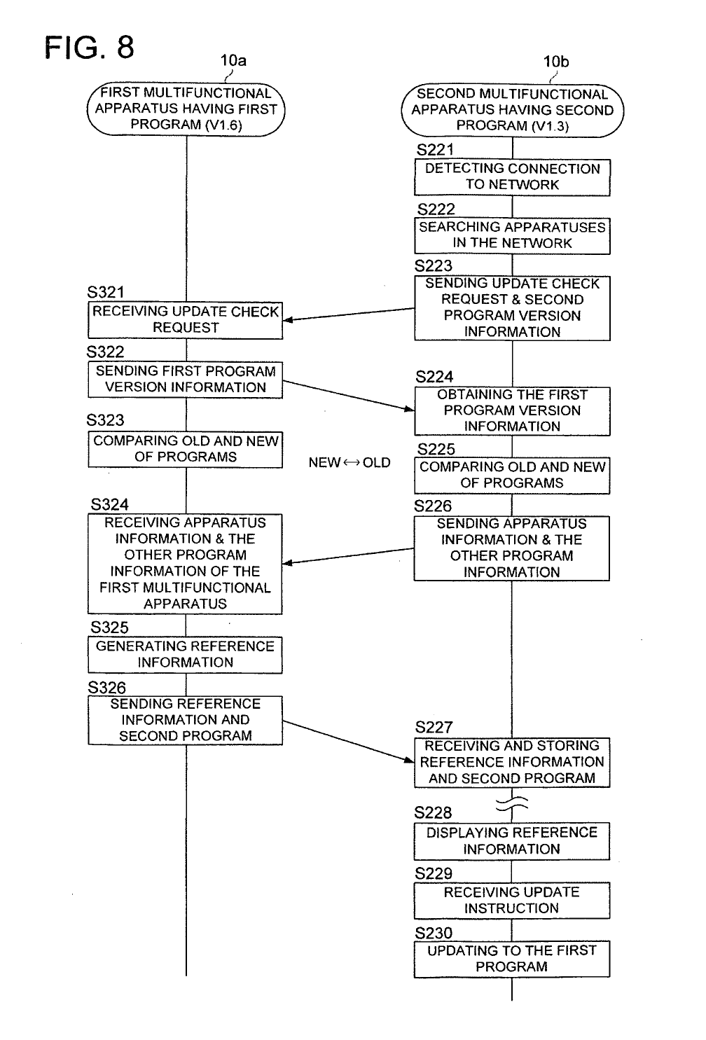

FIG. 8 illustrates an example of operations of the multi-functional apparatuses 10a and 10b in which the second multi-functional apparatus 10b holding the second program (Version V1.3) therein which is older than the first program (Version V1.6) is newly connected to the network 2 with which the first multi-functional apparatus 10a holding the first program (Version V1.6) has been connected. The processes down to the step of comparing old and new of the programs (S221-S225, S321-323) is executed are the same as the steps (S201-205, S301-S303) illustrated in FIG. 7.

Since the second program (V1.3) held by own apparatus is found to be older than the first program (V1.6), as a result of the comparison of old and new of the programs, the second multi-functional apparatus 10b transmits the apparatus information of own apparatus and information related to other program (the third program) to the first multi-functional apparatus (Step S226). The first multi-functional apparatus 10a receives this information (Step S324), generates reference information based on the received information and differences between the first and second programs (Step S325) and transmits the generated reference information and the first program to the second multi-functional apparatus 10b (Step S326). The second multi-functional apparatus 10b receives the information from the first multi-functional apparatus and store them (Step S227).

The stored reference information is displayed on the display/operation section 17 of the second multi-functional apparatus 10b when a user conducts a predetermined operation on the second multi-functional apparatus 10b (Step S228). The user judges whether the user updates the second program to the first program by refereeing to the display. The second multi-functional apparatus 10b updates the second program to the first program (Step S230) when receiving update instruction from the user (Step S229).

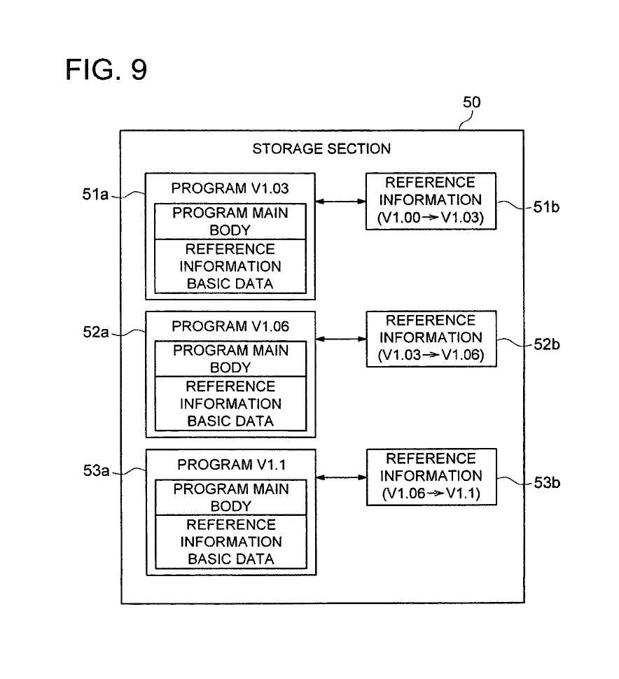

FIG. 9 illustrates an example of a storage section 50, which stores programs and reference information. In the example shown in FIG. 9, a multi-functional apparatus 10 originally held a program having version V1.00. After that, the multi-functional apparatus 10 receives a program 51a having version V1.03 and reference information 51b from other multi-functional apparatus 10. Further, the multi-functional apparatus 10 receives a program 52a having version V1.06 and reference information 52b from other multi-functional apparatus 10. After that, the multi-functional 10 apparatus receives a program 53a having version V1.1 and reference information 53b from other multi-functional apparatus 10.

The reference information 51b, which has been correlated with the program 51a having version V1.03 and stored into the storage section 50 is reference information used when updating the program having version V1.00 to the program 51a having version V1.03. The reference information 51b comprises the changes from version V1.00 to version V1.03 and the introduction advice in the version up from version V1.00 to version V1.03.

The same as above, reference information 52b, which has been correlated with the program 52a having version V1.06 and stored in the storage section 50 is reference information used when updating the program having version V1.03 to the program having version V1.06. Reference information 53b, which has been correlated with the program 53a having version V1.1 and stored in the storage section 50 is reference information used when updating the program having version V1.06 to the program having version V1.1.

As described above, a received program and reference information are correlated and stored in the storage section. Deletion may be conducted based on the instruction of the user or may be automatically deleted when executing the update. In the latter case, when updating a certain version program, programs having older version than the certain version and reference information may be deleted at once.

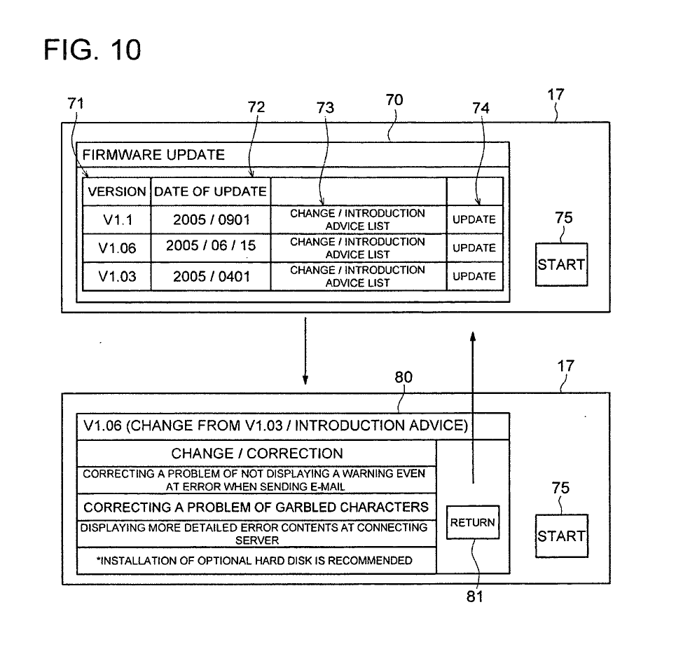

FIG. 10 illustrates an operation screen 70 for updating firmware and a confirmation screen 80. Information related to firmware stored in the storage section 50 is listed and displayed in the operation screen 70. The operation screen 70 comprises a version display column 71 for displaying version information of each firmware, an update-date and time column 72 for displaying the date and the time of update (the date and the time when information is supplied from other multi-functional apparatus 10), a selection button 73 for displaying the contents of the reference information and a update button 74 for inputting update instruction, wherein each column 71 or 72 displays the corresponding information. A start button 75 for starting the update operation is provided in the right hand side of the operation screen 70.

The operation screen 70 in FIG. 10 displays a list of firmware only having newer versions than the version, which has already installed and utilized. However, all version of firmware stored in the storage section 50 may be listed and displayed.

When any one of selection button 73 in the operation screen 70 is operated, the operation screen turns out to the confirmation screen 80 and corresponding reference information is displayed. On the confirmation screen 80, changes/modifications between versions, and advice information are displayed. When operating a RETEUN button 81, the operation screen 70 is displayed.

A user determines whether the update is suitable or not by referring to the reference information displayed on the confirmation screen 80. When determined to update, the user operates the update button 74 corresponding to the program, and further operates the start button 75. Based on these operations, an update operation to a selected program can be executed.

As described above, since the user can determine whether the program update is suitable or not by referring to reference information provided by an apparatus having newer or later version program, it becomes possible to avoid useless update and update which causes inconveniences. As a result, it becomes possible to selectively update the current program to the one, which the user wants.

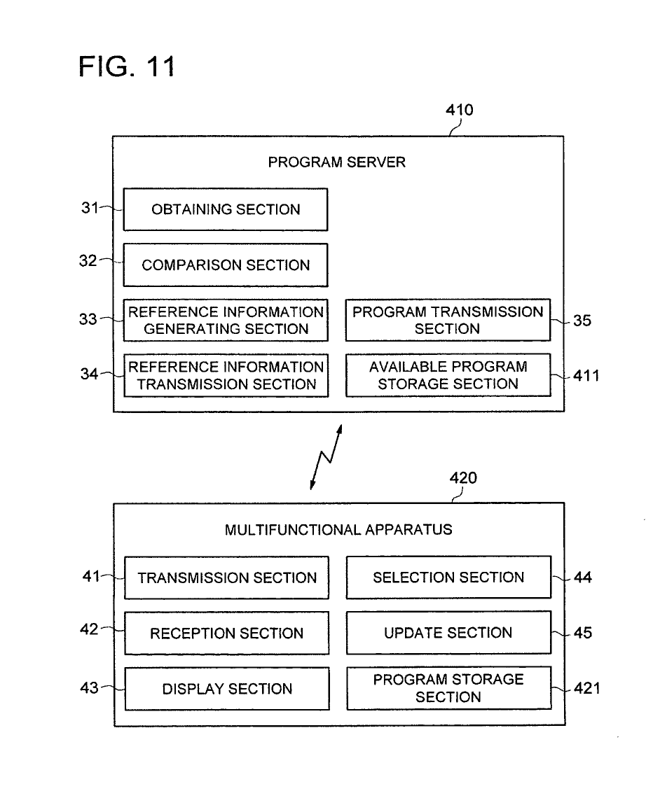

FIG. 11 illustrates a data processing apparatus of the second embodiment of the present invention. In the first embodiment, the multi-functional apparatus 10 is configured by the information providing section 30 and the introduction section 40 as a data processing apparatus having both functions as illustrated in FIG. 3. However, in the second embodiment, a data processing apparatus having a function as the information providing section 30 is configured as a program server 410, and a data processing apparatus having a function as the introducing section 40 is separately configured into a separate body as a multi-functional apparatus 420. The same mark is given to the structural portion of the same function as shown in FIG. 3, and those explanation will be omitted.

An available program storage section 411 in the program server 410 is a storage apparatus for storing programs, which can be provided by the program server 410 to external devices such as multi-functional apparatus 420 and multi-functional apparatuses 10. The same as the program 60 shown in FIG. 4, the program main body 61 and the reference information basic data 62 configure the program stored in the available program storage section 411. A program storage section 421 has a function for storing programs and reference information provided by the program server 410 and the multi-functional apparatus 10.

As described above, even though in the case that a data processing apparatus for proving programs and reference information, and a data processing apparatus for receiving and installing the programs and the reference information therein are separately configured, since the data processing apparatus for providing the programs and the reference information provides the reference information to the data processing apparatus which receives the reference information, the user can determine whether the update is suitable or not by using the provided reference information. AS a result, it becomes possible to avoid useless update and update which causes inconveniences. Further it becomes possible to selectively update the current program to the one, which the user wants.

The present invention is not limited to the above embodiments and various changes and modification may be made without departing from the scope of the invention.

In these embodiments described above, the program together with the reference information is provided to the external device. However, it is also possible to firstly provide the reference information, and later the program may be provided only when the external device requests the program later.

The multi-functional apparatus may also be configured so that when the apparatus configuration or the condition related to the application program have been changed after obtaining the reference information, the multi-functional apparatus transmits the apparatus information which describing the current or updated situation and information related to other programs to the apparatus originally provided the reference information in order to obtain the reference information corresponding to the apparatus for receiving the program and reference information.

In these embodiments described above, a series of processes related to update of a program is designed to start when an apparatus is connected with the network 2. However, the multi-functional apparatus may be arranged to periodically execute the series of process for updating the program or execute the series of process for updating the program based when receiving a user's request.

It is not necessary that the program and reference information are managed together or as a unit. The program and reference information may be separately handled as long as the correlation between the program and the reference information is maintained.

In the embodiments described above, the version information is exchanged between the same type apparatuses. However, when the program does not depend on the type of apparatus, or the program can be used across a plurality of apparatuses, it is possible to configure the multi-functional apparatus so that the multi-functional apparatus exchanges the version information with all apparatuses, which hold a program having different version from the version of the program held by own apparatus.

In the embodiments described above, the display/operation section 17 is arranged to display the reference information. However, the reference information may be transmitted to an external terminal such as a personal computer, on which a user specifies to display the reference information. In this case, the external terminal may be arranged to accept update instruction.

According to the data processing apparatus of the present invention, since an apparatus including a newer or later version program transmits reference information, which is going to be a judging material whether the older version program is updated to a newer version program or not to an apparatus including an older version program, a user can determines whether the user updates the program or not based on the reference information and it becomes possible to avoid the useless program update and update causing inconveniences. Consequently, it becomes possible to selectively update the program, which the user only wants to install.

In the apparatus, which transmits the reference information corresponding to apparatus information and property information of a program after obtaining the apparatus information of the apparatus including older version program and the property information of the program, since the reference information corresponding to the property of each external device can be provided, a user can surly and swiftly determine whether the program update is suitable or not.

According to the preferred embodiment of the present invention, the data processing apparatus transmits reference information for a user to determine whether updating to the later version program is necessary or not to the external device connected with network, when obtaining the version information of the program stored in the external device, comparing the version information of the program stored in the external device to the version of the program in the data processing apparatus and having determined the version of the program in the data processing apparatus is later than the version of the program in the external device.

With regard to the reference information, for example, there are differences between the programs of the external device and the data processing apparatus, inconveniences caused by the later programs and information with regard to optional apparatuses to be added. The first program and the second program denote that the first and second programs have the same version or different versions but are the same type of program.

With regard to obtaining the version information by the obtaining section, the data processing apparatus may request external devices to transmit version information back to the data processing apparatus or the data processing apparatus may simply wait for receiving the version information from the external device. It does not matter what the moment of the obtaining operation for the version information is. The data processing apparatus may be an apparatus capable of supplying a program to the external device via network. The data processing apparatus is not limited to a printer and a

According to the preferred embodiment of the present invention, the data processing apparatus obtains the first version information of the first program stored in the external device and compares the first version information with the second version information of second program. When the second program stored in the data processing apparatus is later than the first program, the data processing apparatus transmits reference information to the external device for a user to determine whether the second program substitutes the first program or not.

Meanwhile, when the first program is later than the second program stored in the data processing apparatus, the data processing apparatus receives the reference information from the external device and presents the received reference information to the user. Then the data processing apparatus accepts the instruction of the user whether the first program substitutes the second program or not.

The external device may be the other data processing apparatus having the same function as the data processing apparatus or a program server. In a system where a plurality of data processing apparatuses is connected with network, the reference information is transmitted from a data processing apparatus having a later version program to a data processing apparatus having an older version program. In the data processing apparatus having an older version program, the user determines whether later version program substitutes the older version program or not.

What is claimed is:

1. A data processing apparatus connected with an external device via network, comprising:
an obtaining section to obtain first version information of first program stored in the external device;
a comparison section to compare the first version information with second version information of second program stored in the data processing apparatus;
a reference information generating section to generate reference information, which is used in the external device for determining whether the second program substitutes the first program or not, when the second program is later than the first program in accordance with a result of a comparison by the comparison section; and
a reference information transmission section to transmit the reference information to the external device.

2. The data processing apparatus of claim 1, further comprising:
a program transmission section to transmit the second program to the external device, when the second program is later than the first program.

3. The data processing apparatus of claim 2, wherein the program transmission section transmits the second program with the reference information.

4. The data processing apparatus of claim 1, further comprising:
a second obtaining section to obtain device information of the external device,
wherein the reference information generating section generates the reference information in accordance with the device information.

5. The data processing apparatus of claim 1, further comprising:
a third obtaining section to obtain attribution information of third program stored in the external device, which relates to the first program,
wherein the reference information generating section generates the reference information in accordance with the attribution information of the third program.

6. The data processing apparatus of claim 1, wherein the obtaining section starts operation thereof, when the data processing apparatus connects the network.

7. The data processing apparatus of claim 1, wherein the obtaining section starts operation thereof, when the external device connects the network.

8. The data processing apparatus of claim 1, wherein each section of the data processing apparatus starts operation thereof in accordance with a user instruction or a request by an external device.

9. The data processing apparatus of claim 1, wherein the reference information includes information relating to a difference between the first program and the second program.

10. The data processing apparatus of claim 1, wherein the reference information includes advice information relating to program update.

11. The data processing apparatus of claim 1, wherein the reference information includes information notifying that a trouble may be occurred by program updating.

12. The data processing apparatus of claim 1, wherein the reference information includes information relating to another program, which is required in program updating.

13. The data processing apparatus of claim 1, wherein the reference information includes information relating to an optional device, which is required in program updating.

14. The data processing apparatus of claim 1, wherein the first program and the second program include information for generating the reference information, respectively.

15. A data processing apparatus connected with an external device storing first program via network, comprising:
a transmission section to transmit version information of second program stored in the data processing apparatus;
a reception section to receive reference information, which is used for determining whether the first program substitutes the second program or not, when the first program is later than the second program;
a display section to display the reference information for a user;
a selection section to accept an instruction of the user whether the first program substitutes the second program or not; and
an update section to update the second program by the first program, when the instruction is accepted at the selection section.

16. The data processing apparatus of claim 15, further comprising:
a storage section to store the reference information, wherein the display section displays the reference information stored in the storage section, and the selection section accepts selection of program corresponding to the reference information as substitution for the second program.

17. The data processing apparatus of claim 15, wherein the transmission section starts operation thereof, when the data processing apparatus connects the network.

18. The data processing apparatus of claim 15, wherein the transmission section starts operation thereof, when the external device connects the network.

19. The data processing apparatus of claim 15, wherein each section of the data processing apparatus starts operation thereof in accordance with a user instruction or a request by an external device.

20. The data processing apparatus of claim 15, wherein the reference information includes information relating to a difference between the first program and the second program.

21. The data processing apparatus of claim 15, wherein the reference information includes advice information relating to program update.

22. The data processing apparatus of claim 15, wherein the reference information includes information notifying that a trouble may be occurred by program updating.

23. The data processing apparatus of claim 15, wherein the reference information includes information relating to another program, which is required in program updating.

24. The data processing apparatus of claim 15, wherein the reference information includes information relating to an optional device, which is required in program updating.

25. The data processing apparatus of claim 15, wherein the first program and the second program include information for generating the reference information, respectively.

26. A data processing apparatus connected with an external device via network, comprising:
an obtaining section to obtain first version information of first program stored in the external device;
a transmission section to transmit second version information of second program stored in the data processing apparatus;
a comparison section to compare the first version information with the second version information of second program stored in the data processing apparatus;
a reference information generating section to generate first reference information, which is used in the external device for determining whether the second program substitutes the first program or not, when the second program is later than the first program in accordance with a result of a comparison by the comparison section;
a reference information transmission section to transmit the first reference information to the external device;
a reception section to receive second reference information, which is used for determining whether the first program substitutes the second program or not, when the first program is later than the second program in accordance with the result of the comparison;
a display section to display the second reference information for a user;
a selection section to accept an instruction of the user whether the first program substitutes the second program or not; and
an update section to update the second program by the first program, when the instruction is accepted at the selection section.

27. The data processing apparatus of claim 26, further comprising:
a program transmission section to transmit the second program to the external device, when the second program is later than the first program.

28. The data processing apparatus of claim 26, wherein the program transmission section transmits the second program with the first reference information.

29. The data processing apparatus of claim 26, further comprising:
a second obtaining section to obtain device information of the external device from the external device,
wherein the reference information generating section generates the reference information in accordance with the device information.

30. The data processing apparatus of claim 26, further comprising:
a third obtaining section to obtain attribution information of third program stored in the external device, which relates to the first program,
wherein the reference information generating section generates the reference information in accordance with the attribution information of the third program.

31. The data processing apparatus of claim 26, further comprising:
a storage section to store the second reference information,
wherein the display section displays the reference information stored in the storage section, and the selection section accepts selection of program corresponding to the reference information as substitution for the second program.

32. The data processing apparatus of claim 26, wherein the obtaining section starts operation thereof, when the data processing apparatus connects the network.

33. The data processing apparatus of claim 26, wherein the obtaining section starts operation thereof, when the external device connects the network.

34. The data processing apparatus of claim 26, wherein each section of the data processing apparatus starts operation thereof in accordance with a user instruction or a request by an external device.

35. The data processing apparatus of claim 26, wherein the reference information includes information relating to a difference between the first program and the second program.

36. The data processing apparatus of claim 26, wherein the reference information includes advice information relating to program update.

37. The data processing apparatus of claim 26, wherein the reference information includes information notifying that a trouble may be occurred by program updating.

38. The data processing apparatus of claim 26, wherein the reference information includes information relating to another program, which is required in program updating.

39. The data processing apparatus of claim 26, wherein the reference information includes information relating to an optional device, which is required in program updating.

40. The data processing apparatus of claim 26, wherein the first program and the second program include information for generating the reference information, respectively.
